(19) United States
(12) Patent Application Publication
(10) Pub. No.: US 2026/0056804 A1
(43) Pub. Date: Feb. 26, 2026

(54) APPLICATION AWARE RESOURCE QUOTA FOR VIRTUAL ENVIRONMENTS

(71) Applicant: Red Hat, Inc., Raleigh, NC (US)

(72) Inventors: Fabian Deutsch, Grasbrunn (DE); Barak Mordehai, Ra'anana (IL); Vladislav Romanovsky, Quebec City (CA)

(21) Appl. No.: 18/814,162

(22) Filed: Aug. 23, 2024

(51) Int. Cl. G06F 9/50; G06F 9/455

(52) U.S. Cl. CPC G06F 9/5077; G06F 9/45558; G06F 2009/45595

(57) ABSTRACT

A method includes receiving a request to deploy a virtual resource associated with an application, creating the virtual resource in view of the request, and placing the virtual resource in a scheduling queue. The method further includes determining whether a resource quota associated with the application comprises sufficient space for the virtual resource, and in response to determining that the virtual resource fits within the resource quota, deploying the virtual resource associated with the application.

### TECHNICAL FIELD

Aspects of the present disclosure relate to resource quota management in virtualized computing systems, and more particularly, application aware resource quota gating for virtual environments.

### BACKGROUND

Container orchestration system provide processes for managing the deployment, integration, scaling, and lifecycles of containerized software and applications in complex, dynamic environments. In some examples, container orchestration systems can be extended to deploy other virtual environments, such as virtual machines. Container orchestration systems may also utilize resource quotas for limiting and managing the computing resources consumed by virtual resources associated with a user or namespace of the container orchestration system.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram that illustrates an example system for resource quota management in a virtual environment, in accordance with some embodiments.

FIG. 2 is a block diagram that illustrates an example system for resource quota management using a scheduling gate, in accordance with embodiments of the disclosure.

FIG. 3 is a block diagram of an example computing system for resource quota management, in accordance with some embodiments.

FIG. 4 is a flow diagram of a method of resource quota management in virtual environments, in accordance with some embodiments.

FIG. 5 depicts a flow diagram of resource quota management for deployment of applications in a virtual environment, in accordance with some embodiments.

FIG. 6 is a block diagram of an example apparatus that may perform one or more of the operations described herein, in accordance with some embodiments of the present disclosure.

### DETAILED DESCRIPTION

Container orchestration systems, such as Kubernetes™ include a mechanism to limit resource consumption per namespace. For example, some container orchestration systems provide a resource quota object that defines a quota for the namespace. To calculate the resource usage of a namespace, conventional container orchestration systems use primitive objects to calculate the usage of various resources, such as central processing unit (CPU) utilization and memory consumption. Such primitive objects are themselves virtual environments and therefore do not necessarily map to the physical resources requested on the pod that runs a container or virtual machine.

Conventional container orchestration systems do not have the capability to adapt resource quotas to applications that utilize or generate additional virtual resources for functions such as live migrations. For example, when a virtual machine is deployed within or by a container orchestration system, when live migration is performed, an extra pod (e.g., a target pod) is created which is counted against the overall resource quota of the namespace. If the quota is exceeded by the extra pod, then the creation of the extra pod may be prevented, and the live migration will fail. Such limitations can further limit other functionality, such as preventing performance of cluster upgrades which may rely on live migration. Similarly, other applications or functionalities may be limited by the resource quota even though the application itself does not exceed the resource quota.

Aspects of the disclosure address the above-noted and other deficiencies by providing a quota resource controller for determining application-specific resource usage and applying an application-specific policy. The quota resource controller may operate at a scheduling level of a container orchestration system, which allows the initiation of the creation of a new pod or virtual resources without the prevention of the resource creation. For example, the quota resource controller may add an indicator, herein referred to as a scheduling gate, to each newly requested pod within the namespace it operates in that indicates whether the resource quota allows for the added virtual resource without being exceeded. The quota resource controller may then continuously calculate the resource usage of the current running pods of the associated application to adjust the quota usage calculation. Upon determining that the quota usage allows for the additional resource to be deployed, the scheduling gate is removed (e.g., set to indicate that the resource is allowed under the quota), thus allowing the resource to be scheduled and deployed.

In some embodiments, because the resource quota is defined to be application-specific, the resource controller may calculate resource usage of the virtual resources expressed by a particular application (e.g., virtual machine) rather than the resources on the pod deploying the application. Additionally, the quota resource controller may count each resource just once rather than counting duplicated resources during application migration. Thus, resources of a second pod generated during a live migration are not counted toward the resource quota. Furthermore, the application-specific nature of the resource quota allows for crafting of special policies for users of a cluster.

By providing an application-specific resource quota controller that uses a scheduling gate for quota management, embodiments described herein allow for reliable live migration of applications in a container orchestration system. Additionally, embodiments provide for dynamic creation and scheduling of virtual resources (e.g., pods) that allow for flexible resource allocation and deployment. Furthermore, the application-specific resource quotas and policies provide for more flexible policy definition across users and more granular control of resource quota management.

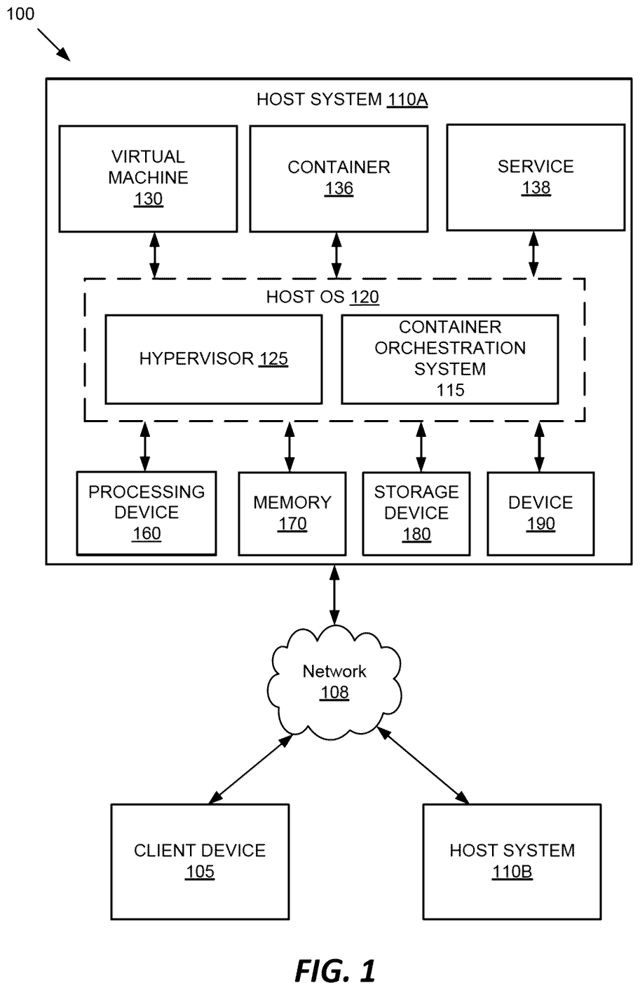

FIG. 1 depicts a high-level component diagram of an illustrative example of a computer system architecture 100, in accordance with one or more aspects of the present disclosure. One skilled in the art will appreciate that other computer system architectures are possible, and that the implementation of a computer system utilizing examples of the invention are not necessarily limited to the specific architecture depicted by FIG. 1.

As shown in FIG. 1, computer system architecture 100 includes host systems 110A-B and client device 105. The host systems 110A-B include one or more processing devices 160, memory 170, which may include volatile memory devices (e.g., random access memory (RAM)), non-volatile memory devices (e.g., flash memory) and/or other types of memory devices, a storage device 180 (e.g., one or more magnetic hard disk drives, a Peripheral Component Interconnect [PCI] solid state drive, a Redundant Array of Independent Disks [RAID] system, a network attached storage [NAS] array, etc.), and one or more devices 190 (e.g., a Peripheral Component Interconnect [PCI] device, network interface controller (NIC), a video card, an I/O device, etc.). In certain implementations, memory 170 may be non-uniform access (NUMA), such that memory access time depends on the memory location relative to processing devices 160A. It should be noted that although, for simplicity, host system 110A is depicted as including a single processing device 160, storage device 180, and device 190 in FIG. 1, other embodiments of host systems 110A may include a plurality of processing devices, storage devices, and devices. Similarly, client device 105 and host system 110B may include a plurality of processing devices, storage devices, and devices. The host systems 110A-B and client device 105 may each be a server, a mainframe, a workstation, a personal computer (PC), a mobile phone, a palm-sized computing device, etc. In embodiments, host systems 110A-B may be separate computing devices. In some embodiments, host systems 110A-B may be included in a cluster of computing devices. For clarity, some components of client device 105 and host system 110B are not shown. Furthermore, although computer system architecture 100 is illustrated as having two host systems, embodiments of the disclosure may utilize any number of host systems. For example, computer system architecture 100 may include a cluster of computing nodes in which host systems 110A-B are included.

Host system 110A may additionally include one or more virtual machines (VMs) 130, containers 136, and host operating system (OS) 120. VM 130 is a software implementation of a machine that executes programs as though it were an actual physical machine. Container 136 acts as an isolated execution environment for different functions of applications. The VM 130 and/or container 136 may be an instance of a serverless application or function for executing one or more applications of a serverless framework. In some examples, the virtual machine 130 may be deployed on or across one or more containers 136. Host OS 120 manages the hardware resources of the computer system and provides functions such as inter-process communication, scheduling, memory management, and so forth.

Host OS 120 may include a hypervisor 125 (which may also be known as a virtual machine monitor (VMM)), which provides a virtual operating platform for VMs 130 and manages their execution. Hypervisor 125 may manage system resources, including access to physical processing devices (e.g., processors, CPUs, etc.), physical memory (e.g., RAM), storage device (e.g., HDDs, SSDs), and/or other devices (e.g., sound cards, video cards, etc.). The hypervisor 125, though typically implemented in software, may emulate and export a bare machine interface to higher level software in the form of virtual processors and guest memory. Higher level software may comprise a standard or real-time OS, may be a highly stripped-down operating environment with limited operating system functionality, and/or may not include traditional OS facilities, etc. Hypervisor 125 may present other software (i.e., “guest” software) the abstraction of one or more VMs that provide the same or different abstractions to various guest software (e.g., guest operating system, guest applications). It should be noted that in some alternative implementations, hypervisor 125 may be external to host OS 120, rather than embedded within host OS 120, or may replace host OS 120. Additionally, host OS 120 may include a container orchestration system 115 for management and deployment of containers 136, as well as virtual machines 130 and services 138 within containers 136.

The host systems 110A-B and client device 105 may be coupled (e.g., may be operatively coupled, communicatively coupled, may communicate data/messages with each other) via network 108. Network 108 may be a public network (e.g., the internet), a private network (e.g., a local area network (LAN) or wide area network (WAN)), or a combination thereof. In one embodiment, network 108 may include a wired or a wireless infrastructure, which may be provided by one or more wireless communications systems, such as a WiFi™ hotspot connected with the network 108 and/or a wireless carrier system that can be implemented using various data processing equipment, communication towers (e.g., cell towers), etc. The network 108 may carry communications (e.g., data, message, packets, frames, etc.) between the various components of host systems 110A-B and/or client device 105. In some embodiments, host system 110A and 110B may be a part of a computing cluster of a computing platform (e.g., PaaS system).

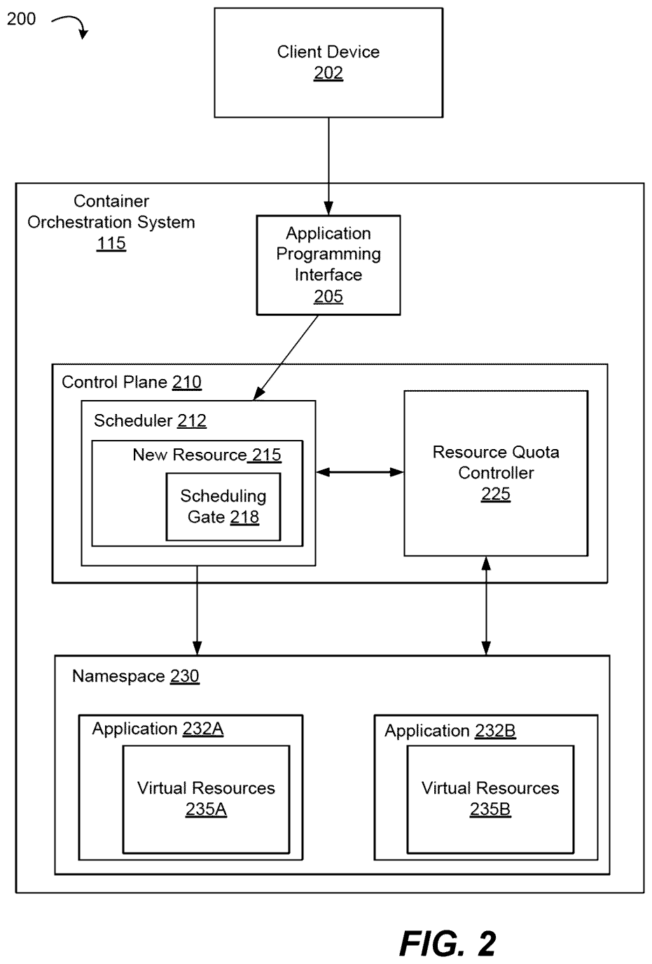

In some examples, a resource quota controller may be deployed by container orchestration system 115 of host system 110A. The resource quota controller may manage resource quotas associated with namespaces of the container orchestration system 115 as well as resource quotas for various applications executed within the namespaces. A namespace may be a set of computing resources assigned to, or associated with, a user in which the user may execute applications, containers, virtual machines, etc. A resource quota for the namespace may define the amount of computing resources that the namespace is allowed to utilize at any given time. A resource quota for an individual application may define the amount of computing resources allowed to be used by a given application at one time. Upon receiving a request for a new virtual resource to be instantiated and deployed by the container orchestration system 115, the resource quota controller may attach or set an indicator, referred to herein as a scheduling gate, of the new virtual resource to indicate that the new virtual resource should not yet be deployed. For example, the scheduling gate may indicate that the resource quota associated with the namespace, or the application will be exceeded if the new virtual resource is deployed and thus should not be deployed. Accordingly, the new virtual resource may remain in the scheduling queue until the scheduling gate is removed. In some examples, the resource quota controller may continuously, or intermittently, calculate the computing resources used by each application and namespace and determine if the new virtual resource fits within the resource quota of its associated application and namespace. If the new virtual resource fits within the resource quota, the resource quota controller removes the scheduling gate, or otherwise sets the value of the indicator to indicate that the new virtual resource is ready and okay to be deployed. Further details regarding the resource quota controller of the container orchestration system 115 will be discussed at FIGS. 2-6 below.

FIG. 2 is a block diagram that illustrates a system 200 for application-specific resource quota management, according to some embodiments. As depicted, system 200 may include a client device 202 in communication with a container orchestration system 115 for deploying and managing virtual workloads (e.g., virtual machines, containers, services, etc.). The client device 202 may be a virtual machine, container, server, a mainframe, a workstation, a personal computer (PC), a mobile phone, a palm-sized computing device, or any other virtual or hardware computing device. As described with respect to FIG. 1, the container orchestration system 115 may be deployed by an operating system of a computing node (e.g., virtual computing node or hardware node). The container orchestration system 115 may include an application programming interface (API) 205 with which the client device 202 may interact to access the container orchestration system 115. The client device 202 may be in communication with the API 205 via a network (e.g., a public network (e.g., the internet), a private network (e.g., a local area network (LAN) or wide area network (WAN)), or a combination thereof). For example, the client device 202 may initiate requests to the container orchestration system 115 through API 205 to deploy computing workloads via virtual resources. The API 205 may receive and forward requests to the control plane 210 of the container orchestration system 115.

The control plane 210 may control scheduling, deployment, and management of virtual resources deployed by the container orchestration system 115 as well as deploying workloads, performing load balancing, etc. The control plane 210 may execute within a control node or pod of the container orchestration system 115 and may control other working nodes, pods, containers, and so forth. In some examples, upon receiving a request from the client device 202 for deployment of a new virtual resource, performance of a new workload, or any other request associated with creating new virtual resources for an application or namespace, the API 205 may forward the request to the control plane 210. The control plane 210 may create a new resource 215 based on the request and the requirements of the request. Upon the creation of the new resource 215, a resource quota controller 225, or other component of the control plane 210, may insert a scheduling gate 218 into the new resource 215. In some examples, the scheduling gate 218 may be a flag or other indicator which can be checked by the scheduler 212 to determine if the new resource 215 is ready to be deployed. In some examples, the scheduling gate 218 includes a webhook that can be accessed by the scheduler 212 as well as the resource quota controller 225 so that the scheduling gate 218 can be updated or removed by the resource quota controller 225.

Once the new resource 215 has been created and the scheduling gate 218 added to, or associated with, the new resource 215, the resource quota controller 225 may identify calculate a resource usage of an application with which the new resource 215 is associated. For example, a namespace 230 of the container orchestration system 115 may execute one or more applications 232A-B, each of which include virtual resources 235A-B that utilize a set of physical computing resources. The resource quota controller 225 may identify the corresponding application with which the new resource 215 is associated and determine the amount of computing resources utilized by the application (e.g., used by the virtual resources of the application). For example, the new resource 215 may be a new pod that is to be added to application 232A. The resource quota controller 225 may identify the application 232A and the virtual resources 235A and determine the amount of computing resources used by the virtual resources 235A of the application 232A. The resource quota controller 225 may further identify a resource quota (e.g., indicated by a resource quota object or attribute) of the application 232A.

In some examples, the resource quota controller 225 may calculate the remaining computing resources available within the resource quota for the application 232A and determine if the resources required of the new resource 215 will fit within the remaining quota (e.g., that the resources available within the quota will be sufficient to execute the new resource 215 without exceeding the quota). If the new resource 215 will not fit within the quota, then the resource quota controller 225 leaves the scheduling gate 218 unchanged. If, however, the resource quota controller 225 determines that resources are available within the quota for the new resource 215, the resource quota controller 225 removes the scheduling gate 218 (e.g., either removes it completely, or updates the indicator to a value indicating that the new resource 215 is ready for deployment). The scheduler 212 may then detect that the scheduling gate 218 has been removed from the new resource 215 and proceed with scheduling the new resource 215 for deployment to the application 232A.

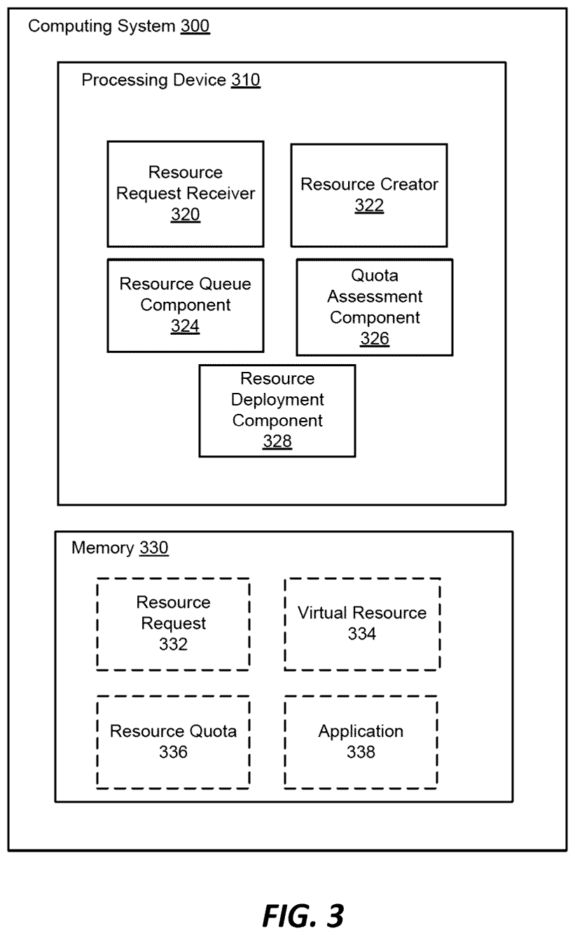

FIG. 3 is a block diagram illustrating a computing system 300 for application-specific resource management in virtual environments, according to some embodiments. Computing system 300 includes processing device 310 and memory 330. Memory 330 may include volatile memory devices (e.g., random access memory (RAM)), non-volatile memory devices (e.g., flash memory) and/or other types of memory devices.

The processing device 310 may be provided by one or more general-purpose processing devices such as a microprocessor, central processing unit, or the like. In some embodiments, processing device 310 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302 may include one or more special-purpose processing devices such as an application specific integrated circuit (ASIC), a field programmable gate array (FPGA), a digital signal processor (DSP), network processor, or the like. The processing device 310 may be configured to execute the operations described herein, in accordance with one or more aspects of the present disclosure, for performing the operations and steps discussed herein. For example, processing device 310 may execute a resource request receiver 320, resource creator 322, resource queue component 324, quota assessment component 326, resource deployment component 328.

In one example, resource request receiver 320 may be an API of a container orchestration system and may receive a resource request 332 from a client device to execute a workload or to otherwise generate a new virtual resource within a namespace of the container orchestration system. The resource request receiver 320 may provide the resource request 332 to resource creator 322. The resource creator 322 may identify the requirements of the resource request 332 and determine the type of virtual resource to be created and an amount of computing resources that are to be allocated to the resource. For example, the resource creator 322 may determine that the resource request 332 is includes a request to perform a live migration of a virtual machine, or other application, from one pod or container to another pod or container (e.g., to perform an update of the virtual machine). The resource creator 322 may thus create a new pod or container (e.g., destination pod or container) to receive the virtual machine. In another example, the resource request 332 may include a request to execute a workload. The resource creator 322 may therefore determine that an additional virtual resource is to be created for executing the requested workload. In another example, the resource request 332 may be a request to instantiate a new virtual resource. Accordingly, the resource creator 322 may generate a virtual resource 334 including the determined computing resources based on the resource request 332.

The new virtual resource 334, however, may cause a resource quota 336 to be exceeded. Therefore, resource queue component 324 may add the virtual resource 334 into a queue for scheduling but mark the virtual resource 334 to indicate that the virtual resource 334 is not ready for deployment. For example, the resource queue component 324 may add a scheduling gate (e.g., a flag or other indicator) to indicate that that the virtual resource 334 should not be scheduled due to resource quota 336 limitations. Accordingly, the new virtual resource 334 may remain in the scheduling queue until the scheduling gate is removed or updated to indicate that the virtual resource 334 can be deployed.

The quota assessment component 326 may determine whether the virtual resource 334 can fit within the resource quota 336. For example, the quota assessment component 326 may monitor the computing resource utilization associated with an application 338 with which the virtual resource 334 is associated (e.g., for which the virtual resource 334 is being deployed). The quota assessment component 326 may then determine an amount of computing resources remaining available under the resource quota 336 for the application 338. For example, the quota assessment component 326 may determine the difference between the resource quota 336 and the computing resource utilization of the application 338. The quota assessment component 326 may then determine if the difference is larger than the amount of resources necessary to deploy the virtual resource 334. If the different is larger, then the quota assessment component 326 may remove the scheduling gate from the virtual resource 334 to allow the virtual resource 334 to be scheduled and deployed. Once the scheduling gate is removed, resource deployment component 328 may deploy the virtual resource 334 to the application 338 within the container orchestration system. Therefore, using the scheduling gate for new virtual resources deployed to an application along with application-specific resource quotas, various functionalities such as live migration may be reliability performed rather than failed and resource quotas can be tailored for specific users and applications.

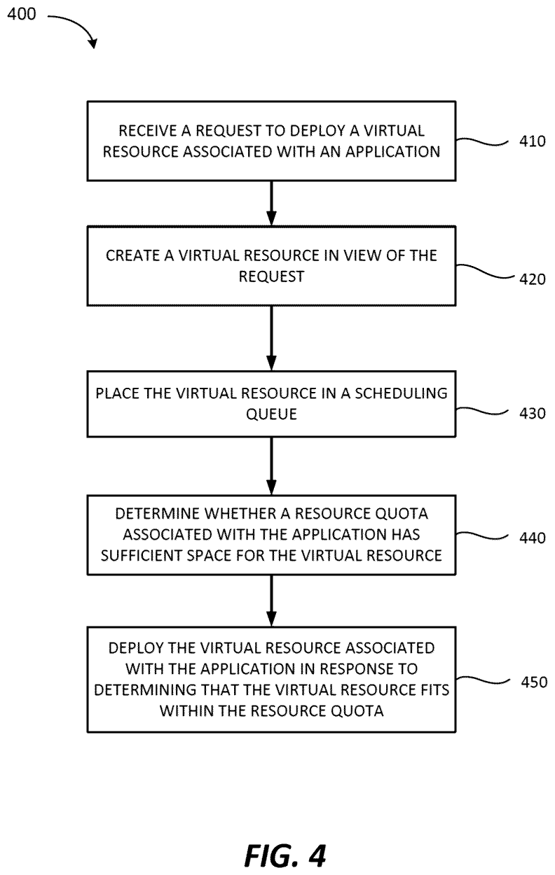

FIG. 4 is a flow diagram of a method 400 of application-specific resource quota management in virtual environments, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by container orchestration system 115 and/or resource quota controller 225 of FIGS. 1 and 2.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic receives a request to deploy a virtual resource associated with an application. At block 420, the processing logic creates a virtual resource in view of the request.

At block 430, the processing logic places the virtual resource in a scheduling queue. In some examples, prior to placing the virtual resource int eh scheduling queue, the processing logic sets an indicator (e.g., a scheduling gate) associated with the virtual resource to a first value. In some embodiments, the indicator may include a flag, a webhook, or other indicator accessible to be updated within the scheduling queue. In some examples, the first value for the indicator of the virtual resource indicates that the virtual resource does not fit within the resource quota.

At block 440, the processing logic determines whether a resource quota associated with the application has sufficient space for the virtual resource. In some embodiments, to determine whether the resource quota associated with the application comprises sufficient space for the virtual resource, the processing logic iteratively determines resource usage of the application and quota availability and determines if the virtual resource fits within the quota availability. In response to determining that the virtual resource fits within the resource quota, the processing logic updates the indicator associated with the virtual resource to a second value (e.g., indicating that the virtual resource fits within the resource quota and is thus ready for deployment). The processing logic then deploys the virtual resource in response to the indicator being set to the second value.

At block 450, the processing logic deploys the virtual resource associated with the application in response to determining that the virtual resource fits within the resource quota. In some examples, the application includes a virtual machine deployed on within a container orchestration system.

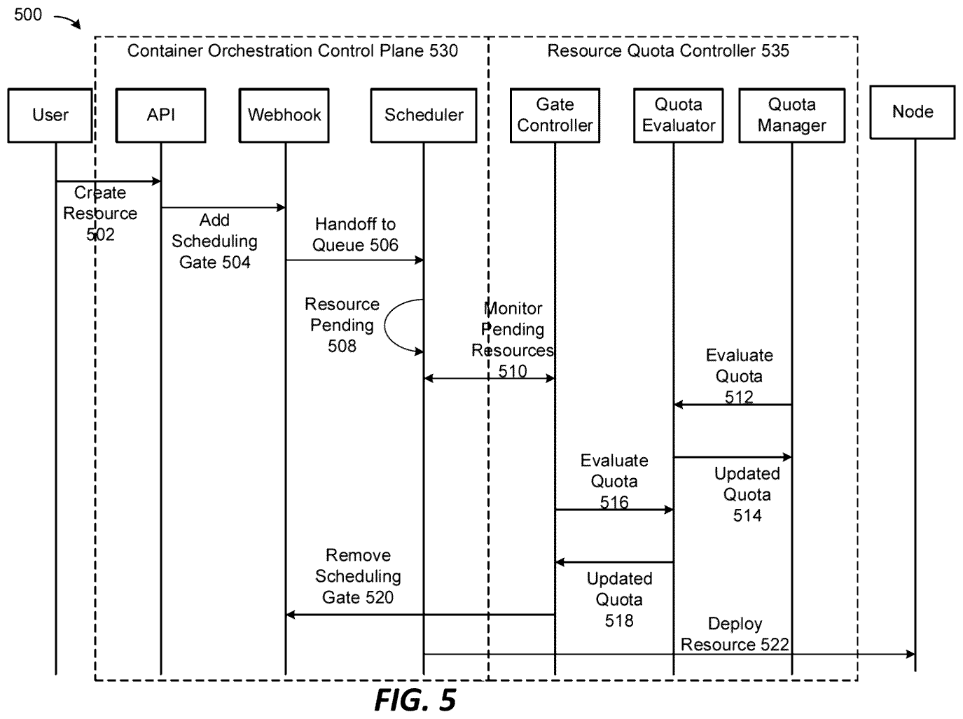

FIG. 5 is a flow diagram of a method 500 of resource quota management for deployment of applications in a virtual environment, in accordance with some embodiments. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by container orchestration system 115 and/or resource quota controller 225 of FIGS. 1 and 2

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at operation 502, where a user initiates creation of a resource via an API of a container orchestration control plane 530 (e.g., of a container orchestration system). At operation 504, a webhook is used to add a scheduling gate 504 to the newly created resource. At operation 506, the newly created resource, with the added scheduling gate, is handed off to a queue of a scheduler. The new resource then remains pending 508 in the scheduler queue until the scheduling gate is removed.

At operation 510, a gate controller of a resource quota controller 535 monitors the pending resources 510 and manages the removal of the scheduling gate upon determining that the new resource fits within the quota associated with an application to which the resource is to be deployed. At operations 512 and 514, a quota evaluator evaluates a quota managed by the quota manager and returns an updated quota.

At operations 516 and 518, the quota evaluator evaluates the quota against the resources associated with the pending resource and returns the updated quota evaluation. The gate controller, upon determining that the quota is satisfied at operation 518, removes the scheduling gate (operation 520) of the pending resource via the webhook. Once the scheduling gate is removed, the scheduler deploys the new resource (operation 522) to a worker node of the container orchestration system.

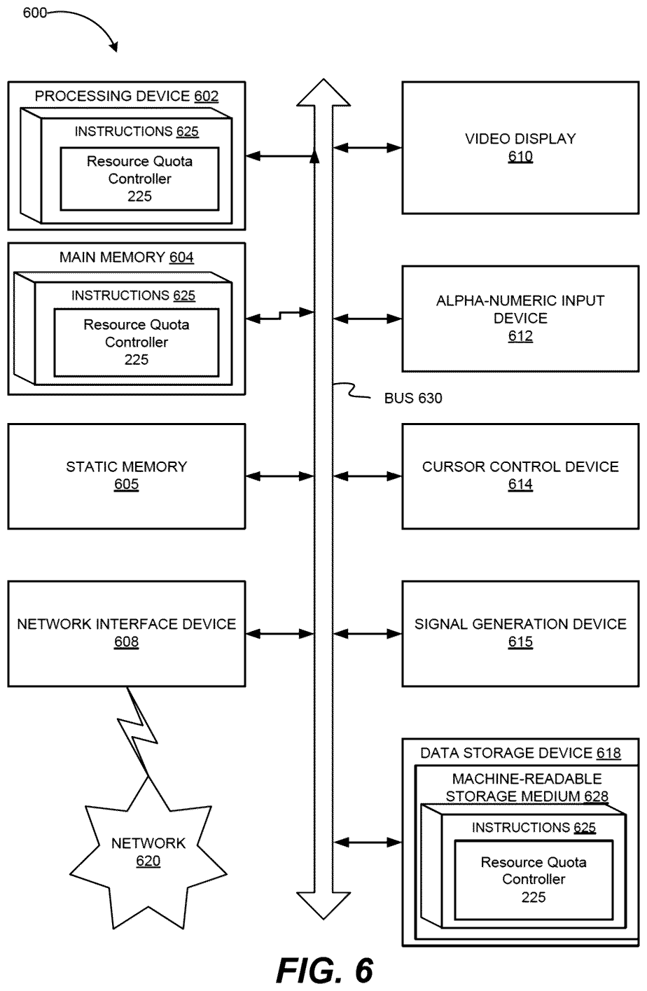

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general-purpose processor, a PLD, etc.) 602, a main memory 604 (e.g., synchronous dynamic random-access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for resource quota controller, e.g., resource quota controller 225 of FIG. 2, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608. Embodiments may further include a computer program product including instructions 625 that, when executed by a processor (e.g., processing device 602), implement the resource quota controller 225 described herein.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “creating,” “placing,” “determining,” “deploying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a request to deploy a virtual resource associated with an application;
creating the virtual resource in view of the request;
placing, by a processing device, the virtual resource in a scheduling queue;
determining, by the processing device, whether a resource quota associated with the application comprises sufficient space for the virtual resource; and
in response to determining that the virtual resource fits within the resource quota, deploying the virtual resource associated with the application.

2. The method of claim 1, further comprising:
setting, prior to placing the virtual resource in the scheduling queue, an indicator associated with the virtual resource to a first value.

3. The method of claim 2, wherein the first value indicates that the virtual resource does not fit within the resource quota.

4. The method of claim 2, wherein determining whether the resource quota associated with the application comprises sufficient space for the virtual resource comprises:
iteratively determining resource usage of the application and quota availability; and
determining if the virtual resource fits within the quota availability.

5. The method of claim 2, further comprising, in response to determining that the virtual resource fits within the resource quota:
updating the indicator associated with the virtual resource to a second value; and
deploying the virtual resource in response to the indicator being set to the second value.

6. The method of claim 2, wherein the indicator comprises a webhook added to the virtual resource.

7. The method of claim 1, wherein the application comprises a virtual machine deployed on within a container orchestration system.

8. A system comprising:
a memory; and
a processing device operatively coupled to the memory, the processing device to:
receive a request to deploy a virtual resource associated with an application;
create the virtual resource in view of the request;
place the virtual resource in a scheduling queue;
determine whether a resource quota associated with the application comprises sufficient space for the virtual resource; and
in response to determining that the virtual resource fits within the resource quota, deploy the virtual resource associated with the application.

9. The system of claim 8, wherein the processing device is further to:
set, prior to placing the virtual resource in the scheduling queue, an indicator associated with the virtual resource to a first value.

10. The system of claim 9, wherein the first value indicates that the virtual resource does not fit within the resource quota.

11. The system of claim 9, wherein to determine whether the resource quota associated with the application comprises sufficient space for the virtual resource, the processing device is to:
iteratively determine resource usage of the application and quota availability; and
determine if the virtual resource fits within the quota availability.

12. The system of claim 9, wherein the processing device is further to, in response to determining that the virtual resource fits within the resource quota:
update the indicator associated with the virtual resource to a second value; and
deploy the virtual resource in response to the indicator being set to the second value.

13. The system of claim 9, wherein the indicator comprises a webhook added to the virtual resource.

14. The system of claim 8, wherein the application comprises a virtual machine deployed on within a container orchestration system.

15. A non-transitory computer-readable storage medium including instructions that, when executed by a processing device, cause the processing device to:
receive a request to deploy a virtual resource associated with an application;
create the virtual resource in view of the request;
place the virtual resource in a scheduling queue;
determine whether a resource quota associated with the application comprises sufficient space for the virtual resource; and
in response to determining that the virtual resource fits within the resource quota, deploy the virtual resource associated with the application.

16. The non-transitory computer-readable storage medium of claim 15, wherein the processing device is further to:
set, prior to placing the virtual resource in the scheduling queue, an indicator associated with the virtual resource to a first value.

17. The non-transitory computer-readable storage medium of claim 16, wherein the first value indicates that the virtual resource does not fit within the resource quota.

18. The non-transitory computer-readable storage medium of claim 16, wherein to determine whether the resource quota associated with the application comprises sufficient space for the virtual resource, the processing device is to:
iteratively determine resource usage of the application and quota availability; and
determine if the virtual resource fits within the quota availability.

19. The non-transitory computer-readable storage medium of claim 16, wherein the processing device is further to, in response to determining that the virtual resource fits within the resource quota:
update the indicator associated with the virtual resource to a second value; and
deploy the virtual resource in response to the indicator being set to the second value.

20. The non-transitory computer-readable storage medium of claim 16, wherein the indicator comprises a webhook added to the virtual resource.
